(19) United States
(12) Patent Application Publication
(10) Pub. No.: US 2004/0049588 A1
(43) Pub. Date: Mar. 11, 2004

(54) Access management server, method thereof, and program recording medium

(75) Inventors: Daisuke Shinohara, Tokyo (JP); Ryoji Furuhashi, Tokyo (JP); Hirotaka Nakagawa, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/428,181

(22) Filed: Apr. 30, 2003

(30) Foreign Application Priority Data
Sep. 5, 2002 (JP) 2002-259520

(51) Int. Cl. G06F 15/16

(52) U.S. Cl. 709/229; 713/201; 713/202

(57) ABSTRACT

According to the prior art, it has been impossible for each program vendor to permit only specific alliance partners to use extended programs having high value-added functions.

An access management server according to an embodiment of the present invention limits access from a first computer to a second computer. There is provided a program ID specification section which allows the first computer to execute a first program to specify an ID of the first program and an ID of a second program based on execution request information for the second program stored in the second computer. Further, there is provided an execution means for allowing the second computer to execute the second program when a program authentication, as a result, permits an access from the first computer to the second computer based on an ID of the first program, an ID of the second program, and program authentication information indicative of an ID of the first program access-permitted for each ID of the second program. The program authentication is provided to limit whether or not to enable access from the first computer to the second computer.

### BACKGROUND OF THE INVENTION

The present invention relates to an access limitation method for a program maintained in a target computer, and particularly to a technology for managing access limitations between programs.

Recently, in the program vendor business, there is a world-wide trend toward systematizing the open management for program usage in order to freely provide users with interoperability of programs developed by a plurality of vendors.

On the premise that a program of a given company is to be used, it becomes possible to use an extended program of any other companies. Users can use more highly functional programs. An extended program can be developed on the premise of using another company's program having excellent functionality, placing more expectations on quantum improvement in development of the program functionality.

Under the open management system as mentioned above, however, there is considered to be a demand for strategically reinforcing alliances like the former state before the open management system in such a manner that each vendor permits only specific alliance partners to use extended programs having high value-added functions.

Conventionally, there is available a technology for preventing the illegal use of software information as disclosed in patent document 1 (see FIG. 8 on page 1 of JP-A No. 108479/2002).

Patent document 1 describes the access management method for an information processing system that distributes software information via a network. The method manages user accesses to the software information based on a user ID and an ID specific to the software information. The technology disclosed in patent document 1 limits accesses to the software information in an access destination based on an ID specific to the software information maintained in the access destination. However, the technology does not limit accesses to the software information based on a program ID under execution by an accessing computer or this computer's ID.

Vendors could not provide a program service of permitting only specific alliance partners to use extended programs having high value-added functions in the open management system for freely providing users with interoperability of programs developed by any vendors. Accordingly, vendors could not satisfy the demand for strategically reinforcing alliances by permitting only specific alliance partners to, use extended programs having high value-added functions.

### SUMMARY OF THE INVENTION

It is an object of the present invention to provide an access right management method with which each program vendor can permit only specific alliance partners to use extended programs having high value-added functions.

In order to achieve the above-mentioned object, the access management server as an embodiment of the present invention limits access to a second computer from a first computer and comprises a request information generation means for allowing the first computer to execute a first program and to generate execution request information for a second program stored in the second computer. The access management server further comprises a program ID specification section to specify an ID of the first program and an ID of the second program based on the execution request information. The access management server moreover comprises a program authentication means for determining whether or not to enable access to the second computer from the first computer based on an ID of the first program, an ID of the second program, and program authentication information indicative of an ID of the first program access-permitted for each ID of the second program. The access management server furthermore comprises an execution means for allowing the second computer to execute a second program when the program authentication means produces an authentication result to be access-permitted.

The access management server according to another embodiment of the present invention limits access to a second computer from a first computer and comprises a computer ID specification means for specifying an ID of the first computer and an ID of the second computer based on execution request information. The access management server further comprises a computer authentication means for determining whether or not to enable access to the second computer from the first computer based on the ID of the first computer, the ID of the second computer, and computer authentication information indicative of the ID of the first computer access-permitted for each ID of the second computer. The access-management server furthermore comprises an execution means allowing the second computer to execute a second program when the computer authentication means produces an authentication result to be access-permitted.

In the access management server according to another embodiment of the present invention, it is preferable to use a WWN, IP address, or MAC address for an ID of the first computer and an ID of the second computer.

The access management program according to still another embodiment of the present invention allows a computer to execute access management for limiting an access from a first computer to a second computer and implements a program ID specification function for specifying an ID of a first program and an ID of a second program based on execution request information. The access management program further implements a program authentication function for determining whether or not to enable access to the second computer from the first computer based on an ID of the first program, an ID of the second program, and program authentication information indicative of an ID of the first program access-permitted for each ID of the second program. The access management program furthermore implements an execution function for allowing the second computer to execute the second program when an authentication result is found to be access-permitted.

The computer according to yet another embodiment of the present invention functions as a first computer having an access management means for limiting access to a second computer and comprises a request information generation means for executing a first program to generate execution request information for a second program stored in the second computer. The computer further comprises a program ID specification section for specifying an ID of the first program and an ID of the second program based on execution request information. The computer moreover comprises a program authentication means for determining whether or not to enable access to the second computer based on an ID of the first program, an ID of the second program, and program authentication information indicative of an ID of the first program access-permitted for each ID of the second program. The computer further more comprises an execution means for allowing the second computer to execute a second program when the program authentication means produces an authentication result to be access-permitted,

The computer according to still yet another embodiment of the present invention functions as a second computer having an access management means for limiting access from a first computer and comprises a request information generation means for allowing the first computer to execute a first program to generate execution request information for a second program stored in the second computer. The computer further comprises a program ID specification section for specifying an ID of the first program and an ID of a second program based on execution request information. The computer moreover comprises a program authentication means for determining whether or not to enable access from the first computer based on an ID of the first program, an ID of the second program, and program authentication information indicative of an ID of the first program access-permitted for each ID of the second program. The computer furthermore comprises an execution means for executing a second program when the program authentication means produces an authentication result to be access-permitted.

### BRIEF DESCRIPTION OF THE DRAWINGS

FIG. 1 shows a configuration of a network system according to an embodiment of the present invention;

FIG. 2 shows a configuration of execution request information for an operation program;

FIG. 3 shows user authentication information;

FIG. 4 shows program authentication information;

FIG. 5 shows a flow of registering the user authentication information;

FIG. 6 is a flowchart showing a process of generating the execution request information for the operation program; and

FIG. 7 is a flowchart showing a process of permitting an access to the operation program for execution from an access management server 200.

### DETAILED DESCRIPTION OF THE PREFERRED EMBODIMENTS

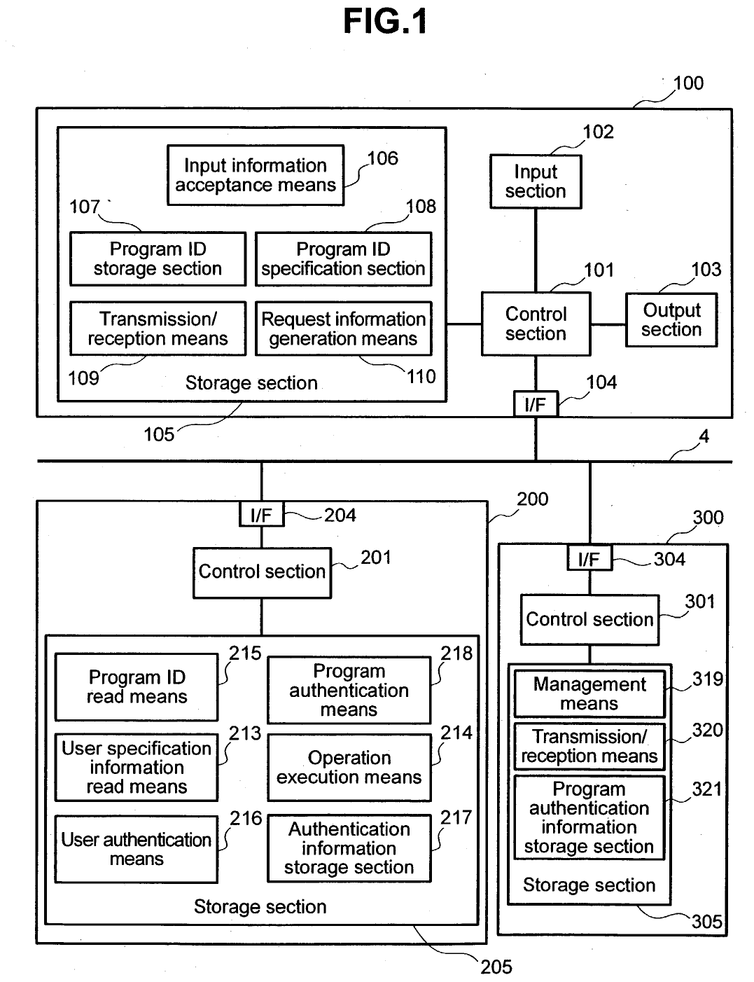

FIG. 1 shows a configuration of a network system according to an embodiment of the present invention.

The reference numeral 100 represents a user's client computer, 300 a target computer maintaining an operation program, and 200 an access management server determining whether or not to permit access from the client computer 100 to the operation program in the target computer 300. The client computer 100, the access management server 200, and the target computer 300 are connected to a network 4 via their own interfaces (I/F) 104, 204, and 304. The network 4 includes network forms such as an IP (Internet Protocol) network, SAN (Storage Area Network), and the like.

The client computer 100 comprises an input section 102; an output section 103; an input information acceptance means 106 for accepting input information from a user; a program ID storage section 107 for storing a program ID, i.e., an identification assigned to each program; a program ID specification section 108 for specifying an active client program and an operation program requested for execution; a request information generation means 110 for generating request information to execute the operation program; and a transmission/reception means 109 for interchanging the generated request information, information needed to register users, and the like with the access management server 300.

There is provided a program functioning as the input information acceptance means 106, the program ID storage section 107, the program ID specification section 108, the transmission/reception means 109, and the request information generation means 110. The program is recorded on a recording medium such as CD-ROM, is stored on a magnetic disk or the like, and then is loaded into a storage section 105 for execution. The program may be recorded on the other storage media than CD-ROM. The program may be installed in the storage section 105 from the storage medium. It may be also preferable to use the program by accessing the storage medium via the network. There may be a hardware configuration independent of a control section 101 of the client computer 100 for functioning as the input information acceptance means 106, the program ID storage section 107, the program ID specification section 108, the transmission/reception means 109, and the request information generation means 110.

The input information acceptance means 106 accepts an operation program execution request from a user and user specification information comprising a user ID and a password as input information via the input section 102.

The program ID storage section 107 stores a client program ID and an operation program ID as a program ID.

The program ID specification section 108 specifies an ID of the active client program and an ID of the operation program requested for execution based on information stored in the program ID storage section 107 and the operation program execution request accepted by input information acceptance means 106.

The request information generation means 110 generates user specification information 12-2 and 12-3, and execution request information for executing the operation program. The execution request information is provided with a client program ID 12-4 and an operation program ID 12-5 specified by the program ID specification section 108. When the input information acceptance means 106 accepts input information, the request information generation means 110 receives program authentication information 18 from an authentication information storage section 217 in the access management server 200. Based on the program authentication information 18, it maybe found that the active client program is an execution request to the access-permitted operation program. Only in such case, the request information generation means 110 may generate the execution request information. In this case, the execution request information need not be provided with the client program ID and the operation program ID.

A transmission means 109 transmits generated request information, information needed for user registration, etc. to the access management server 300 via an I/F 104.

The access management server 200 comprises a user specification information read means 213 for reading user specification information 12-2 and 12-3 based on request information; a user authentication means 216 for authenticating users; an authentication information storage section 217 for storing information needed for authentication; a program ID read means 215 for reading the program IDs 12-4 and 12-5 based on the request information; a program authentication means 218 for authenticating programs; and an operation execution means 214 for allowing a management means 319 of the target computer 300 to execute programs.

There is provided a program functioning as the user specification information read means 213, the user authentication means 216, the authentication information storage section 217, the program ID read means 215, the program authentication means 218, and the operation execution means 214. The program is recorded on a recording medium such as CD-ROM, is stored on a magnetic disk or the like, and then is loaded into a storage section 205 for execution. The program may be recorded on storage media other than CD-ROM. The program may be installed in the storage section 205 from the storage medium. It may be also preferable to use the program by accessing the storage medium via the network. There may be a hardware configuration independent of a control section 201 of the access management server 200 for functioning as the user specification information read means 213, the user authentication means 216, the authentication information storage section 217, the program ID read means 215, the program authentication means 218, and the operation execution means 214. Further, it may be preferable to arrange the user specification information read means 213, the user authentication means 216, the authentication information storage section 217, the program ID read means 215, the program authentication means 218, and the operation execution means 214 inside the client computer 100 or the target computer 300.

The user specification information read means 213 reads user specification information 12-0 comprising a user-input user ID and password from the request information received from the client computer 100.

The user authentication means 216 authenticates whether a user should be access-permitted based on the user specification information 12-0 and user authentication information 17 as shown in FIG. 3.

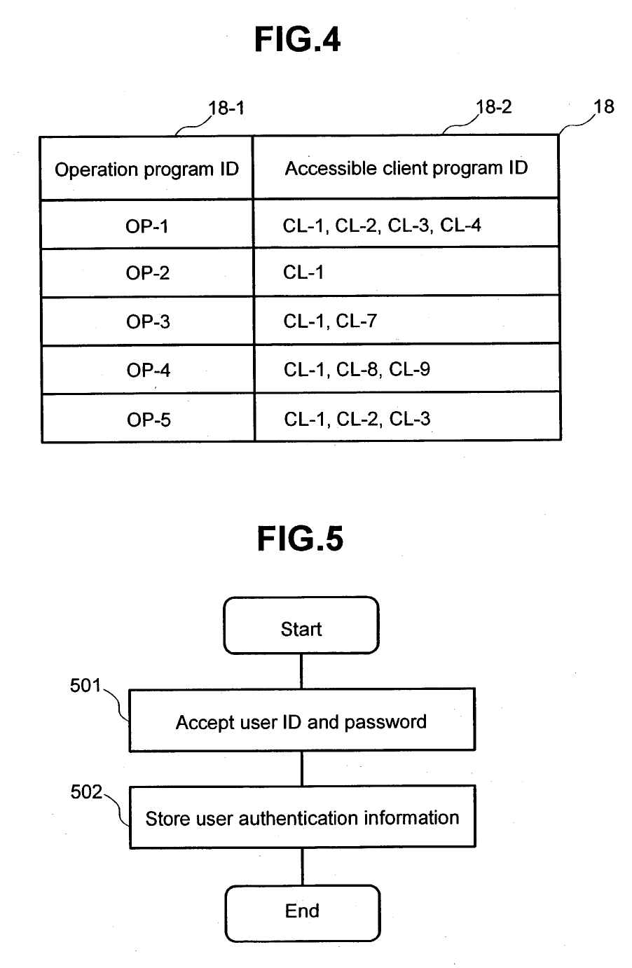

The authentication information storage section 217 stores, as authentication information, user authentication information 17 as shown in FIG. 3 and program authentication information 18 as shown in FIG. 4.

The program ID read means 215 receives a client program ID 12-5 and an operation program ID 12-4 in the request information received from the client computer 100.

The program authentication means 218 performs program authentication based on the client program ID 12-5 and the operation program ID 12-4 read by the program ID read means 215 and on the program authentication information 18. More specifically, the program authentication means 218 authenticates whether or not the client program the client computer 100 is executing is permitted for an access to an operation the user requested to execute.

Based on an authentication result according to the program authentication means 218, the operation execution means 214 allows the management means 319 of the target computer 300 to execute an operation program allowed for the client program the client computer 100 are executing.

The target computer 300 comprises the management means 319 maintaining the operation program; a program authentication information storage section 321 for storing the program authentication information 18; and a transmission/reception means 320 for transmitting program authentication information to the access management server 300.

There is provided a program functioning as the management means 319, the program authentication information storage section 321, and the transmission/reception means 320. The program is recorded on a recording medium such as CD-ROM, is stored on a magnetic disk or the like, and then is loaded into a storage section 305 for execution. The program may be recorded on storage media other than CD-ROM. The program may be installed in the storage section 305 from the storage medium. It may be also preferable to use the program by accessing the storage medium via the network. There may be a hardware configuration independent of a control section 301 of the target computer 300 for functioning as the management means 319, the program authentication information storage section 321, and the transmission/reception means 320.

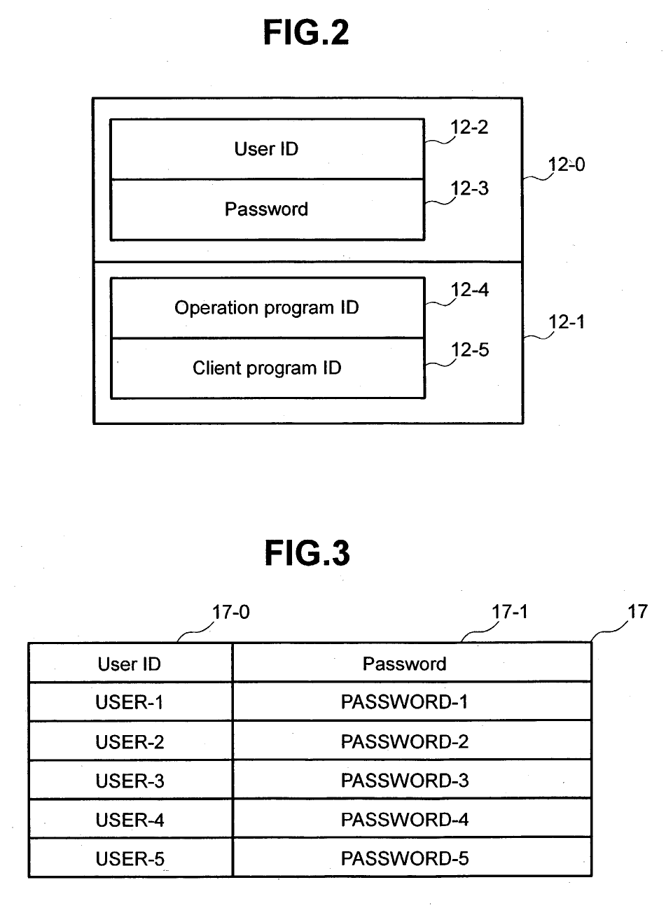

FIG. 2 shows a structure of execution request information for the operation program, wherein the information is created by the request information generation means 110 of the access management server 200.

The execution request information structure comprises a header 12-0 and a body 12-1. The header 12-0 comprises user ID data 12-2 combined with a license key and a password 12-3. The body 12-1 comprises an operation name 12-4 and an operation parameter 12-5.

FIG. 3 shows user authentication information stored in the authentication information storage section 217 of the access management server 200.

The user authentication information contains a user ID 17-0 and a password 17-1 as attributes.

FIG. 4 depicts the program authentication information 18.

The program authentication information 18 indicates a client program ID access-permitted for each operation program ID. The program authentication information 18 may be configured not to limit access to a specific operation program. While the embodiment uses the client program ID as a license key, an ID of the client computer 100 may be used as a license key. While the embodiment uses the operation program ID as a license key, an ID of the target computer 300 may be used as a license key. It is possible to use, e.g., an MAC (Media Access Control) address, an IP address, WWN (World Wide Name), or a combination of these as an ID of the client computer 100 or the target computer 300.

The target computer 300 or the other computers (not shown) can modify the program authentication information 18.

FIG. 5 shows a flow of registering the user authentication information to the authentication information storage section 217 of the access management server 200, wherein the user authentication information is needed for executing the operation program.

First, the input information acceptance means 106 accepts the user authentication information 17 comprising a user ID and a password entered by a user from the input section 102 (step 501). The transmission means 109 of the client computer 100 transmits the user authentication information 17 accepted by the input information acceptance means 106 to the access management server 200. The control section 201 of the access management server 200 stores the received user authentication information 17 in the authentication information storage section 108 (step 502).

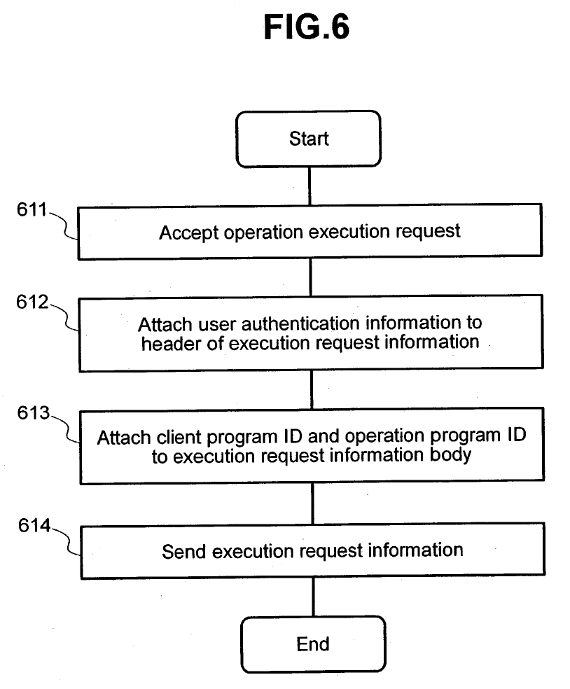

FIG. 6 is a flowchart showing a process of the client computer 100 to generate the execution request information for the operation program

Via the input section 102, the input information acceptance means 106 accepts the user specification information comprising the user ID and the password, an operation name requested for execution by the user, and operation parameters as needed (step 611).

The program ID specification section 108 specifies an active client program ID and an operation program ID requested for execution. The request information generation means 110 generates execution request information for executing a user-requested operation program based on the input information accepted by the input information acceptance means 106 and the program ID specified by the program ID specification section 108. More specifically, the request information generation means 110 adds the user specification information 12-2 and 12-3 to the header 12-0 in the execution request information (step 612). The request information generation means 110 adds the client program ID 12-5 and the operation program ID 12-4 to the body 12-1 in the execution request information (step 613).

The transmission/reception means 109 transmits execution request information created for the access management server (step 614).

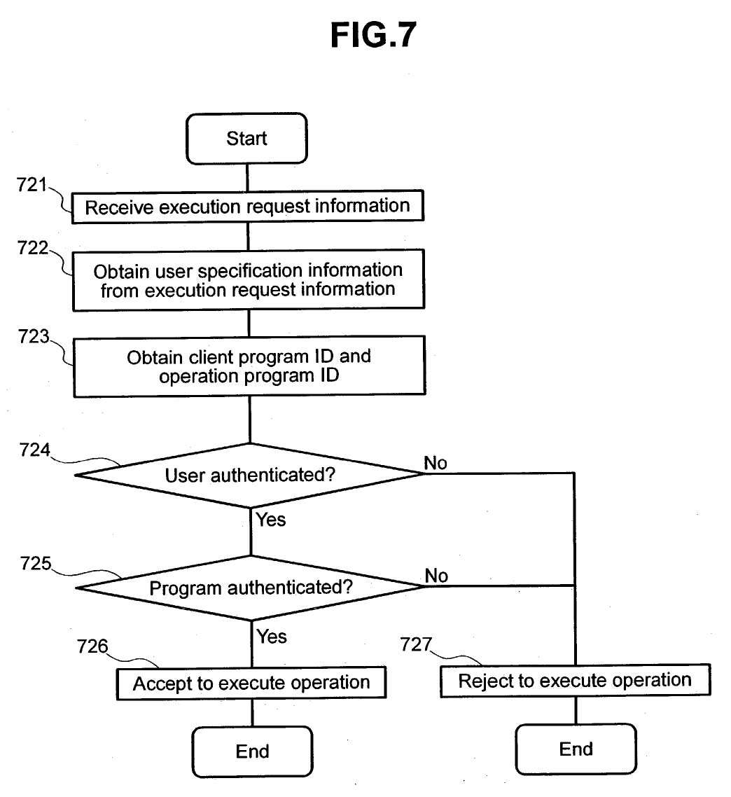

FIG. 7 is a flowchart showing a process of permitting an access to the operation program for execution from the access management server 200.

The user specification information read means 213 receives the execution request information from the client computer 100 (step 721).

The user specification information read means 213 obtains the user specification information 12-2 and 12-3 from the header 12-0 in the execution request information (step 722).

From the body 12-1 of the execution request information, the program ID read means 215 obtains the client program ID 12-5 under execution by the client computer 100 and the operation program ID requested for execution (step 723). The user authentication means 216 performs user authentication to determine whether or not the user is registered, based on the user specification information and the user authentication information stored in the authentication information storage section 217 (step 724). More specifically, the user authentication is assumed to be available if the user ID and the password specified by the user specification information match those contained in the user authentication information. If the user authentication is unavailable, the user authentication means 216 sends an unsuccessful user authentication message to the client computer 100. The control section 101 of the client computer 100 outputs the unsuccessful user authentication message to the output section 103 (step 727).

If the user authentication is assumed to be available, the program authentication means 218 performs program authentication to determine whether or not the client program under execution by the client computer 100 is permitted for access to the operation program (step 725), based on the client program ID and the operation program ID specified by the program ID read means 215 and on the program authentication information. More specifically, the program authentication is assumed to be successful if the client program ID under execution by the client computer 100 and the operation program ID requested for execution specified by the program ID specification section 108 match the client program ID and the operation program ID contained in the program authentication information. If the program authentication is unavailable, the user authentication means 216 sends an unsuccessful program authentication message to the client computer 100. The control section 101 of the client computer 100 outputs the unsuccessful program authentication message to the output section 103 (step 727).

If the program authentication is assumed to be available, the operation execution means 214 sends an operation execution request command to the management means 319 of the target computer 300 (step 726).

In this manner, the embodiment of the present invention can limit the access permission to the operation program for each client program the client computer 100 executes.

The present invention can provide an access right management method with which each program vendor can permit only specific alliance partners to use extended programs having high value-added functions.

What is claimed is:

1. An access management server to limit access to a second computer from a first computer, comprising:
a request information generation means for allowing the first computer to execute a first program and to generate execution request information for a second program stored in the second computer;
a program authentication means for determining whether or not to enable access to the second computer from the first computer based on the execution request information and program authentication information indicative of an ID of the first program access-permitted for each ID of the second program; and
an execution means for allowing the second computer to execute a second program when the program authentication means produces an authentication result to be access-permitted.

2. An access management server to limit access to a second computer from a first computer, comprising:
a computer authentication means for determining whether or not to enable access to the second computer from the first computer based on the execution request information and computer authentication information indicative of an ID of the first computer access-permitted for each ID of the second computer; and
an execution means for allowing the second computer to execute a second program when the computer authentication means produces an authentication result to be access-permitted.

3. The access management server according to claim 2,
wherein an ID of the first computer and an ID of the second computer use a WWN, IP address, or MAC address.

4. A recording medium to store an access management program which allows a computer to execute access management for limiting an access from a first computer to a second computer, wherein the program providing:
a request information generation function for allowing the first computer to execute a first program to generate execution request information for a second program stored in the second computer;
a program authentication function for determining whether or not to enable access to the second computer from the first computer based on the execution request information and program authentication information indicative of an ID of the first program access-permitted for each ID of the second program; and
an execution function for allowing the second computer to execute a second program when the program authentication means produces an authentication result to be access-permitted.

5. An access management method of limiting an access from a first computer to a second computer, comprising the steps of:
allowing the first computer to execute a first program to generate execution request information for a second program stored in the second computer;
determining whether or not to enable access to the second computer from the first computer based on the execution request information and program authentication information indicative of an ID of the first program access-permitted for each ID of the second program; and
allowing the second computer to execute a second program when the authentication result proves to be access-permitted.

6. A first computer having an access management means for limiting access to a second computer, comprising:
a request information generation means for executing a first program to generate execution request information for a second program stored in the second computer;
a program authentication means for determining whether or not to enable access to the second computer based on the execution request information and program authentication information indicative of an ID of the first program access-permitted for each ID of the second program; and
an execution means for allowing the second computer to execute a second program when the program authentication means produces an authentication result to be access-permitted.

7. A second computer having an access management means for limiting access from a first computer, comprising a request information generation means for allowing the first computer to execute a first program to generate execution request information for a second program stored in the second computer;
a program authentication means for determining whether or not to enable access from the first computer based on the execution request information and program authentication information indicative of an ID of the first program access-permitted for each ID of the second program; and
an execution means for executing a second program when the program authentication means produces an authentication result to be access-permitted.

8. A network system comprising a first computer, a second computer, and an access management server to limit access to the second computer from the first computer, wherein the first computer comprises:
a request information generation means for executing a first program to generate execution request information for a second program stored in the second computer; and
a transmission means for transmitting the execution request information to the access management server,
wherein the access management server comprises:
a program authentication means for determining whether or not to enable access to the second computer from the first computer based on the execution request information and program authentication information indicative of an ID of the first program access-permitted for each ID of the second program; and
an execution means for allowing the second computer to execute a second program when the program authentication means produces an authentication result to be access-permitted,
and wherein the second computer comprises:
a management means for executing the second program based on an execution command from the access management server.
